(19) United States
(12) Patent Application Publication
(10) Pub. No.: US 2026/0311715 A1
(43) Pub. Date: Oct. 8, 2026

(54) CROSS-LINGUAL PROSODIC VOICE CLONING IN PLURALITY OF LANGUAGES

(71) Applicant: CAMB AI, INC., Wilmington, DE (US)

(72) Inventor: Akshat PRAKASH, Ghaziabad (IN)

(21) Appl. No.: 19/481,813

(22) PCT Filed: May 6, 2024
(86) PCT No.: PCT/US2024/027978

§ 371 Date: Nov. 5, 2025

(30) Foreign Application Priority Data
May 6, 2023 (IN) 202311014863

(51) Int. Cl. G10L 21/02; G06N 3/0455; G06N 3/08; G10L 17/18

(52) U.S. Cl. CPC G10L 21/02; G06N 3/0455; G06N 3/08; G10L 17/18

(57) ABSTRACT

A system and method for cross-lingual prosodic voice cloning in a plurality of languages. Cross-lingual prosodic voice cloning is the process of cloning prosodic features of a source speaker's voice and transferring them to a target speaker speaking in a different language. This involves capturing rhythm, intonation, and other aspects of source speaker's prosody and applying them to the synthesized speech of the target speaker. The method collects data form speakers or languages. Extract prosodic features from the recordings of the source speaker, such as pitch contour, rhythm, and intensity. Voice cloning generates a baseline voice for the target speaker. The prosodic features extracted from the source speaker are applied to the synthesized voice of the target speaker. A Tacotron performs end to end speech synthesis and the Tacotron produces a spectrogram based on the input. A HIFI GAN vocoder generates a high-quality audio waveform and natural-sounding speech from spectrograms.

### RELATED APPLICATIONS

This application claims the benefit of Indian Patent Application No. 202311014863, filed May 6, 2023, and entitled “A SYSTEM FOR CROSS-LINGUAL PROSODIC VOICE AND MUSIC CLONING IN PLURALITY OF LANGUAGES”, the contents of which is incorporated by reference herein.

### TECHNICAL FIELD

The present invention relates generally to a method and system of cross-lingual cloning with prosody control and more particularly to a method and system that integrates model training and model inference to obtain a new model using a state-of-the-art infrastructure.

### BACKGROUND

Text-to-speech (TTS) systems should be able to generate speech in numerous voices, styles, and ideally in multiple languages in addition to be able to produce comprehensible and natural-sounding speech. Multilingual text-to-speech systems are those that can process text input in multiple languages and generate voice from it. TTS systems that are multilingual have several applications. Besides being used within speech-to-speech language translation systems and interactive language tutoring systems, this functionality is necessary for a TTS system to be able to insert an occasional foreign language word into otherwise monolingual speech, or even to alternate between languages in a manner consistent with the syntax and phonology of each language, which is referred to as code mixing.

Since early 2000s, efforts were made to produce cross-lingual synthesis for concatenative systems, to generate phoneme mappings between the source and destination languages. These methods produced phonetically correct speech output, but because the intonation that is produced, the methods were dependent on the source language, and were mostly useful for producing some foreign words in code-mixing situations. Each spoken language has unique phonetic and prosodic characteristics. The phonetic inventory, phonotactic rules, stress patterns, and rhythm are considerably different between languages. The differences between the source and target languages may result in a non-native accent in the converted speech, which adversely affects the intelligibility of the converted speech.

Cross-language services are not possible with the current technology since the acoustic models of different languages function independently of one another. This causes issues with online music synthesis interface scheduling, makes it impossible to guarantee the consistency of the sound quality of the synthesized songs, and may result in disparate language versions. Users will become confused since the synthesized tunes produced by the acoustic model have an entirely different sound quality.

Therefore, there is still work to be done in the area of computer-intelligent speech synthesis to figure out how to accommodate numerous speakers while maintaining controllable prosody and how to disentangle and apply a speaker's style to other speakers.

In view of the above, the is a well felt need for a system and a method that integrates cross-lingual cloning and prosody control at the same time.

### SUMMARY

A system for cross-lingual prosodic voice cloning in a plurality of languages is provided herein. The system includes an encoding unit comprising a multilingual TTS text encoder configured to encode an input character sequence, a multilingual TTS DAT speaker classifier configured to identify and classify speakers in a multilingual context, a capacitron VAE unit configured to perform learning prosody of speech and provide control during inference, wherein the capacitron VAE unit comprises, a capacitron reference encoder configured to process a reference received information and incorporate it into the encoding and decoding process of the model, a concat configured to combine the plurality of information from the plurality of inputs for merging the inputs, a masking unit configured to handle variable sequence or missing data from the concat data, a soft DTW configured to perform end-to-end training of models that involve time series data alignment, such as speech recognition or time series forecasting, and improve the audio production quality, the system comprising an architecture configured to enable simultaneous prosody control and cross-lingual cloning, and a HIFI GAN vocoder configured to generate a high-quality audio waveform and natural-sounding speech from spectrograms.

Potentially, the multilingual TTS text encoder comprises a decoder or the vocoder configured to generate speech in the desired language.

Potentially, the multilingual TTS text encoder utilizes transformer-based models for efficient encoding of input character sequences.

Potentially, a Tacotron2-like decoder is configured to incorporate attention mechanisms for improved spectrogram generation ration,

Potentially, a tacotron is known for its ability to generate natural-sounding speech with relatively few parameters compared to traditional speech synthesis methods.

Potentially, the concatenation is a fundamental operation in building complex neural network architectures, especially in cases where information from different parts of the network needs to be combined or merged.

Also provided herein is a method for cross-lingual prosodic voice cloning in a plurality of languages, the method includes the steps of encoding, using a multilingual TTS text encoder, an input character sequence, identifying and classifying, using a multilingual TTS DAT speaker classifier, speakers in a multilingual context, performing, using a capacitron VAE unit, learning prosody of speech and providing control during inference, processing, using a capacitron reference encoder, a reference received information and incorporating it into the encoding and decoding process of the model, combining, using a concat, the plurality of information from the plurality of inputs and merging the inputs, handling, using a masking unit, a variable sequence, or missing data from the concat data, performing, using a soft DTW, end-to-end training of models that involve time series data alignment, such as speech recognition or time series forecasting, and improves the audio production quality, the system comprising an architecture that enables simultaneous prosody control and cross-lingual cloning, and generating, using a HIFI GAN vocoder, a high-quality audio waveform, and natural-sounding speech from spectrograms.

In an embodiment, wherein the Soft-DTW loss function is adapted to consider the temporal alignment between predicted and target spectrograms for audio production.

Numerous additional features, embodiments, and benefits of the methods and system of the present invention are discussed below in the detailed description which follows.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

FIG. 1 illustrates an architecture view of the system for cross-lingual cloning with prosody control by model training and model inference, in accordance with the present invention.

FIG. 2 illustrates a flow diagram for cross-lingual cloning with prosody control by model training and model inference, in accordance with the present invention.

Various embodiments will hereinafter be described in accordance with the appended drawings, which are provided to illustrate, and not to limit the scope in any manner, wherein like designations denote similar elements, and in which:

### DETAILED DESCRIPTION

The present subject matter is best understood with reference to the detailed figures and description set forth herein. Various embodiments are discussed below with reference to the figures, However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

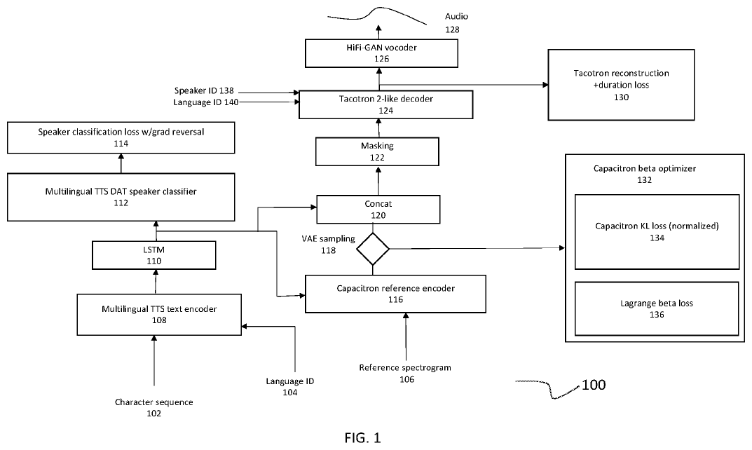

FIG. 1 illustrates an architecture view of a system 100 for cross-lingual cloning with prosody control by model training and model inference, in accordance with the present invention. In particular, the present invention provides a system 100 for cross-lingual prosodic voice cloning in a plurality of languages. The system 100 includes an encoding unit. The encoding unit further comprises a multilingual TTS text encoder 108 that encodes an input character sequence 102. A multilingual Text-to-Speech (TTS) text encoder 108 is a component of a TTS system that is designed to process text in multiple languages and produce a language-independent embedding that may be used by the TTS model to generate speech. The multilingual text encoder 108 is configured to process input text in any supported language and convert it into a fixed-size numerical representation (embedding) that captures the semantic and linguistic content of the text. The encoder is trained on a multilingual corpus that allows it to learn to encode text from different languages into a shared embedding space and enables it to capture common linguistic features across languages. In some embodiments, the encoder produces a language-independent representation and may also incorporate language-specific features or embeddings that help preserve certain linguistic characteristics unique to each language.

A multilingual TTS DAT speaker classifier 112 is configured to identify and classify speakers in a multilingual context. The multilingual TTS DAT speaker classifier 112 combines elements of multilingual text-to-speech (TTS), denoising autoencoder transfer (DAT), and speaker classification. Multilingual TTS enables the system to synthesize speech in multiple languages. DAT is a technique used to learn speaker embeddings from speech data. In some embodiments, DAT involves training a neural network to reconstruct clean speech from corrupted speech, with the network's internal representation serving as a speaker embedding. The learned representation may be transferred to other tasks, such as speaker classification.

A capacitron VAE unit is configured to perform learning prosody of speech and provide control during inference. The capacitron VAE unit comprises a capacitron reference encoder 116 that processes a reference received information 106 and incorporates it into the encoding and decoding process of the model. The Capacitron VAE (Variational Autoencoder) unit is a type of neural network architecture designed for unsupervised learning of representations from sequential data, comprising a time series or sequential text.

A concat 120 is configured to combine the plurality of information from the plurality of inputs and merge the inputs. The concat 120 links together or combines items in a series or chain. In the context of neural networks and deep learning, concatenation typically refers to the operation of joining two or more tensors along a specified axis to create a new tensor. In some embodiments, in deep learning models, concatenation is often used to combine features from different parts of a network or different sources before passing them to the next layer, which allows the model to learn from multiple representations simultaneously. A masking unit 122 is configured to handle variable sequence or missing data from the concat data. The masking unit 122 in the context of neural networks refers to the technique of ignoring certain elements in the input or output tensors during computation. In some embodiments, the masking 122 is used in sequences, such as in natural language processing (NLP) tasks like text generation or machine translation, where sequences of varying lengths are common.

The system further comprises the use of Soft-DTW as a loss function for enhancing the quality of the audio production by considering the alignment between the predicted and target spectrograms. The soft DTW is configured to perform end-to-end training of models that involve time series data alignment, speech recognition, or time series forecasting and improves the audio production quality. The system further comprises a unique architecture that enables simultaneous prosody control and cross-lingual cloning. The Soft Dynamic Time Warping (DTW) is a variant of the traditional DTW algorithm that introduces differentiable approximations, making it suitable for use in deep learning models. DTW is a technique used to compare two sequences of varying lengths and find an optimal alignment between them by warping the time axis. The Soft DTW is particularly useful in sequence-to-sequence tasks in deep learning, such as speech recognition, where aligning sequences of varying lengths is common and allows for end-to-end training of models that involve sequence alignment, making it easier to integrate DTW-like operations into deep learning architectures.

A HIFI GAN vocoder 126 is configured to generate a high-quality audio waveform and natural-sounding speech from spectrograms. The spectrogram output is then fed into the HIFI-GAN vocoder 126 to convert it into high-quality audio, capturing the nuances of the speech. The HiFi-GAN is a generative adversarial network (GAN) architecture specifically designed for high-fidelity speech synthesis. The HiFi-GAN vocoder 126 focuses on improving the quality and realism of synthesized speech, particularly in terms of capturing fine details and nuances.

The vocoder in the context of HiFi-GAN 126 is the part of the model responsible for generating the raw waveform of the synthesized speech. In speech synthesis, the vocoder takes a sequence of acoustic features as input and generates the waveform that corresponds to the speech signal. HiFi-GAN's vocoder 126 is designed to produce high-quality waveforms that closely resemble natural speech.

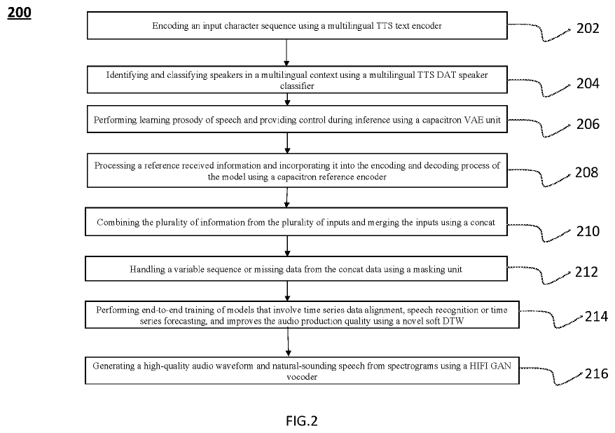

FIG. 2 illustrates a flow diagram of a method 200 for cross-lingual cloning with prosody control by model training and model inference, in accordance with the present invention. In particular, a method for cross-lingual prosodic voice cloning in a plurality of languages is provided herein. The method comprises encoding an input character sequence using a multilingual TTS text encoder at step 202, identifying and classifying speakers in a multilingual context using a multilingual TTS DAT speaker classifier at step 204, performing learning prosody of speech and providing control during inference using a capacitron VAE unit at step 206, processing a reference received information and incorporating it into the encoding and decoding process of the model using a capacitron reference encoder at step 208, combining the plurality of information from the plurality of inputs and merging the inputs using a concat at step 210, handling a variable sequence or missing data from the concat data using a masking unit at step 212, performing end-to-end training of models that involve time series data alignment, speech recognition or time series forecasting, and improves the audio production quality using a soft DTW at step 214, and generating a high-quality audio waveform and natural-sounding speech from spectrograms using a HIFI GAN vocoder at step 216.

In a preferred embodiment, the model training is performed using version 1.8. The model training method comprises data collecting, preprocessing, model initializing, fine-tuning, evaluating, and deploying. The model collects the parallel corpus or monolingual data in the target language, preprocess the data to remove noise and prepares it for training, and initializes the pre-trained language model with weights from a model pre-trained on a large dataset. The model further fine-tunes the pre-trained model on the target language or domain data. The model learns to adapt to the specific linguistic characteristics of the target language or domain. The method further comprises evaluating the adapted model on a separate validation or test set to assess its performance to ensure that the adapted model is effective for the target language or domain. When the adapted model is trained and evaluated satisfactorily, it may be deployed for various natural language processing tasks in the target language or domain.

The mode obtains language and speaker embeddings from the dataset. The model comprises Capacitron VAE that provides the additional ability to learn the prosody of speech and gives the user the control of the same during inference. The Capacitron VAE is used to learn representations of the time series data in different languages or domains that could then be integrated into the adaptation process of the language model. The learned representations assist in capturing the temporal aspects of language use or changes, which is useful in improving the adaptation of the language model to the new language or domain.

The model obtains an input as a character sequence, a reference spectrogram, and computes a target spectrogram that is then converted to audio using a Hi-Fi GAN vocoder 126. The model further comprises a Soft-DTW as a loss function to improve the quality of the generated spectrogram. The character sequence 102 input is converted into some form of feature representation that may be fed into a neural network. The neural network architecture takes both the processed character sequence 102 and the reference spectrogram as input. The input may be of multiple layers, such as convolutional layers, recurrent layers, and possibly attention mechanisms to align the text with the spectrogram. The output of the neural network is a target spectrogram, which is a 2D representation of audio frequencies (y-axis) over time (x-axis). The spectrogram is generated based on the input text and the reference spectrogram. The target spectrogram is converted into audio using the Hi-Fi GAN vocoder 126. The vocoder is a tool used to synthesize speech or other sounds by analyzing and reproducing the spectral characteristics of an audio signal. Soft-DTW is used as a loss function during training to compare the generated spectrogram with the target spectrogram. Soft-DTW is a variant of Dynamic Time Warping (DTW) that allows for soft alignment between sequences, which can lead to higher-quality output. The entire model is trained using a dataset of text and corresponding audio spectrograms. The training process involves optimizing the model's parameters to minimize the difference between the generated spectrograms and the target spectrograms, as measured by the Soft-DTW loss function. Once the model is trained, the model is used to generate spectrograms and convert them into audio for new input text.

The method further comprises training model inference. In this method, a learned spectrogram and speaker ID are provided as input, the model is trained to generate spectrograms from text input and speaker IDs, and the spectrogram is then converted to produce audio using the Hi-FI GAN vocoder. The spectrogram is learned by the model during training based on the input text and speaker ID pairs. The vocoder synthesizes high-quality audio from the spectrogram, capturing the nuances of the speech for the specified speaker ID. The training process involves optimizing the model's parameters to minimize the difference between the generated spectrograms and the target spectrograms.

In some exemplary embodiments, the cross-lingual prosodic voice cloning in 25 languages model may be used to perform music cloning. The method comprises removing the background music from vocals in a song using state-of-the-art models like demucs, fine-tuning the existing voice cloning on singing voices, transcribing and translating the original script with the application of OpenAI's Whisper and language models, and utilizing original song utterances and translated character sequences to produce the target voice for a given song sequence. The last method is repeated for all sequences in the song. In some embodiments, the language models may be at least one of openNMT or M2M Large. In some embodiments, a candidate-based approach may be used to choose hyper-accurate translation with the ability for manual correction.

In some embodiments, the system may be model-trained and inference using version 1.7. The system obtains input character sequence 102 as input and encodes the received data using Multilingual TTS text encoder 108. The encoded data then flows to a Capacitron reference encoder that interacts with other components. A Multilingual TTS DAT speaker classifier is connected to the reference encoder. The data from the reference encoder flows through VAE sampling process. The output from the VAE sampling is processed by a masking unit before reaching a Tacotron2-like decoder. The decoded output is processed to a HiFi-GAN vocoder for generating the final audio waveform. The version 1.7 further comprises a direct connection from the text encoder to the decoder and a feedback loop from the Capacitron beta optimizer to the reference encoder. The version 1.7 further comprises an additional input to the reference encoder from a speaker classification loss w/gradient reversal.

In some embodiments, the existing method relies on an explicit duration prediction system operating on mel-spectrograms. The present method does not use explicit duration prediction and the duration of phones is implicitly learned in the language modeling task on codec units. The present method infers the fundamental frequency and other aspects of prosody from speaker embedding transformer networks. The method operates purely on text sequences. In addition, the speaker prosody and tone characteristics are inferred from a reference utterance, not a specified tone/pitch track. The present method uses a cross-entropy loss to predict discrete speech codec tokens.

The present invention may be used for Movie post-production, AV post-production, AV editing, AV localization, AV internationalization, dubbing, voice-over, personal assistants, music repurposing, and content repurposing. The present invention achieves prosody control and cross-lingual control at the same time with the implementation of the loss function of soft-DTW.

The present system offers advantages such as but not limited to simultaneous prosody control and cross-lingual cloning, along with the implementation of the unique soft-DTW loss function. It finds applications in movie post-production, AV editing, dubbing, voice-over, music repurposing, and content localization. These steps highlight the intricate process of language and speaker embedding learning, prosody control, cross-lingual voice conversion, and music translation and repurposing within the architecture of the TTS system.

The advanced text-to-speech system presented herein represents a significant leap forward in speech synthesis technology. With its innovative features, unique architecture, and superior performance, this system has the potential to revolutionize the way we interact with and consume audio content in diverse multimedia applications. The present system encompasses a comprehensive description of the system, method, and dependent claims, highlighting the inventive features and capabilities of the proposed text-to-speech technology.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is noted that various connections are set forth between elements in the description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprise” and “comprising” should be interpreted as referring to elements, components, or steps, in a non-exclusive manner, indicating that the referenced elements, components, or steps may be present, or utilized, or combined with other elements, components, or steps that are not expressly referenced.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet-card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source, or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C”, “C#”, “C+”, “C++”, “Embedded C”, “Visual C++,” Java”, “Python” and “Visual Basic”. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “iOS”, “Mac” “Unix,” “DOS,” “Android,” Symbian, and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although few implementations have been described in detail above, other modifications are possible. Moreover, other mechanisms for performing the systems and methods described in this document may be used. In addition, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A system for cross-lingual prosodic voice cloning in a plurality of languages, the system comprising:
an encoding unit comprising:
a multilingual text-to-speech (TTS) text encoder configured to encode an input character sequence;
a multilingual TTS denoising autoencoder transfer (DAT) speaker classifier configured to identify and classify speakers in a multilingual context;
a capacitron variational autoencoder (VAE) unit configured to perform learning prosody of speech and provide control during inference, the capacitron VAE unit comprising:
a capacitron reference encoder configured to process a reference received information and incorporate it into encoding and decoding process of a model;
a concat configured to combine a plurality of information from a plurality of inputs for merging the inputs;
a masking unit configured to handle variable sequence or missing data from the concat data;
a soft dynamic time warping (DTW) configured to perform end-to-end training of models that involve time series data alignment, including speech recognition or time series forecasting, and improve an audio production quality, wherein the system comprises an architecture configured to enable simultaneous prosody control and cross-lingual cloning; and
a HIFI generative adversarial network (GAN) vocoder configured to generate a high-quality audio waveform and natural-sounding speech from spectrograms.

2. The system of claim 1, wherein the multilingual TTS text encoder comprises a decoder or a vocoder configured to generate speech in desired language,

3. The system of claim 1, wherein the multilingual TTS text encoder utilizes transformer-based models for efficient encoding of input character sequences.

4. The system of claim 1, wherein a Tacotron2-like decoder is configured to incorporate attention mechanisms for improved spectrogram generation.

5. The system of claim 1, wherein a tacotron generates natural-sounding speech.

6. The system of claim 1, wherein a concatenation operation is used to build complex neural network architectures, where information from different parts of a network is combined or merged.

7. A method for cross-lingual prosodic voice cloning in a plurality of languages, the method comprising:
encoding, using a multilingual text-to-speech (TTS) text encoder, an input character sequence;
identifying and classifying, using a multilingual TTS denoising autoencoder transfer (DAT) speaker classifier, speakers in a multilingual context;
performing, using a capacitron variational autoencoder (VAE) unit, learning prosody of speech and providing control during inference;
processing, using a capacitron reference encoder, a reference received information and incorporating it into an encoding and decoding process of a model;
combining, using a concat, a plurality of information from a plurality of inputs and merging the inputs;
handling, using a masking unit, a variable sequence, or missing data from the concat data;
performing, using a soft dynamic time warping (DTW), end-to-end training of models that involve time series data alignment, including speech recognition or time series forecasting, and improves an audio production quality, wherein the system comprises an architecture that enables simultaneous prosody control and cross-lingual cloning; and
generating, using a HIFI generative adversarial network (GAN) vocoder, a high-quality audio waveform, and natural-sounding speech from spectrograms.

8. The method of claim 7, wherein the Soft-DTW loss function is adapted to consider a temporal alignment between predicted and target spectrograms for audio production.
